(19) United States
(12) Patent Application Publication
(10) Pub. No.: US 2015/0081319 A1
(43) Pub. Date: Mar. 19, 2015

(54) Method for Evaluating Medical Condition Insurability Risk

(71) Applicant: Innodata Synodex, LLC, Hackensack, NJ (US)

(72) Inventors: Richard D. Kemp, Edgewater, NJ (US); Sam Jensen, Larchmont, NJ (US)

(73) Assignee: Innodata Synodex, LLC, Hackensack, NJ (US)

(21) Appl. No.: 14/030,583

(22) Filed: Sep. 18, 2013

(51) Int. Cl. G06Q 40/08; G06Q 50/22

(52) U.S. Cl. CPC G06Q 40/08; G06Q 50/22
USPC 705/2

(57) ABSTRACT

Methods, apparatuses, and computer readable media for evaluating medical condition insurability risk are provided. A digital communication including an indication of a medical condition associated with an individual is received. A presumptive medical condition risk score is generated for the individual based on the indication of the medical condition and presumptive medical condition risk criteria. One or more medical records associated with the individual are retrieved via a data storage device. A composite medical condition risk score for the individual is generated based on the one or more medical records, and a correlation between the presumptive medical condition risk score and the composite medical condition risk score is determined.

### TECHNICAL FIELD

The present disclosure is generally directed to processing medical records, and more specifically to processing medical records for the purpose of evaluating insurability risk associated with a medical condition.

### BACKGROUND

Collecting useful data from medical records is often tedious. Medical records related to a particular individual are often stored at disparate locations. Once these records are located, the task of gathering and analyzing the records is often labor-intensive. Typically, records must be organized and mined for data. Further, if the data is being gathered for input to an automated process, the records may also need to be formatted and data expressed in a normalized manner.

Inaccurate methods of processing medical records can also render impractical certain desirable applications that would require precise medical record data or reliable medical record analytics. For example, it is oftentimes advantageous for reinsurance or other purposes to evaluate insurability risk associated with particular medical conditions. However, due to the inaccurate processing methods currently utilized for underlying medical records, insurability risk is often based on imprecise factors rather than medical record data or analytics.

### SUMMARY

Methods, apparatuses, and computer readable media for evaluating medical condition insurability risk are provided. A digital communication including an indication of a medical condition associated with an individual is received. A presumptive medical condition risk score for the individual is generated based on the indication of the medical condition and presumptive medical condition risk criteria. One or more medical records associated with the individual are retrieved via a data storage device. A composite medical condition risk score for the individual is generated based on the one or more medical records, and a correlation between the presumptive medical condition risk score and the composite medical condition risk score is determined. The correlation between the presumptive medical condition risk score and the composite medical condition risk score may be provided to one of an insurance underwriter or an insurance underwriting broker. The indication of the medical condition may be based on a response to a medical condition questionnaire.

In accordance with an embodiment, one or more other records associated with the individual may be retrieved, and the composite medical condition risk score may be generated based on the one or more other records. The one or more other records associated with the individual may include one of a driving history record or a pharmacy history record.

In accordance with an embodiment, the composite medical condition risk score may be generated based on one of an average, median or modified average of stored medical condition risk scores associated with insurance underwriters. Each stored medical condition risk score may be based on insurability criteria provided by an insurance underwriter, and the comparison of the presumptive medical condition risk score and the composite medical condition risk score may be routed to a particular insurance underwriter to provide for preferred reinsurance rates based on a stored medical condition risk score.

In accordance with an embodiment, the presumptive medical condition risk score may be generated as part of a no-charge insurance underwriting service, and the composite medical condition risk score may be generated as part of a fee-based insurance underwriting service.

In accordance with an embodiment, the one or more medical records may comprise normalized medical reports that include normalized medical data, the normalized medical data including one or more critical disease elements. The normalized medical reports may conform to one or more Association for Cooperative Operations Research and Development insurance data standards.

These and other advantages of the invention will be apparent to those of ordinary skill in the art by reference to the following detailed description and the accompanying drawings.

### BRIEF DESCRIPTION OF THE DRAWINGS

FIG. 1 is a flowchart of a process for medical record processing in accordance with an embodiment;

FIG. 2A illustrates a page of a medical file in accordance with an embodiment;

FIG. 2B illustrates another page of a medical file in accordance with an embodiment;

FIG. 3 illustrates a data-point file in accordance with an embodiment;

FIG. 4 illustrates a coded file wherein the data-points are coded according to one or more medical record coding standards in accordance with an embodiment;

FIG. 5 is a flowchart of a process for generating a selected pool of underwritten insurance policies in accordance with an embodiment;

FIG. 6 is a workflow diagram showing an environment that may be used for evaluating medical condition insurability risk in accordance with an embodiment;

FIG. 7 is a flowchart of a process for evaluating medical condition insurability risk in accordance with an embodiment; and

FIG. 8 is a high-level block diagram of an exemplary computer that may be used for the various embodiments herein.

### DETAILED DESCRIPTION

In free-market conditions, insurance underwriters operate independently, and each independent insurer will evaluate similar medical conditions (e.g., disease, risk of disease, etc.) and other risk factors according to their own risk standards. For example, Underwriter A may calculate an insurability risk score for coronary heart disease (CAD) with 1 blockage of 50% or less to be +200% of a (base line) premium. Underwriter B may calculate an insurability risk score for CAD to be +300% of the premium. Underwriter C may score CAD as a decline (no underwriting offer). Underwriter D may score CAD as +150% of the premium, and Underwriter E may score CAD as +100% of the premium, if total cholesterol is <150. In another example, a surcharge (i.e., a dollar amount) may be added to a base line premium according to an underwriter's risk standards for a medical condition. As such, an underwriter may add a $2000 surcharge to a base line premium calculation for a policy when, for example, a patient has diabetes. These surcharge amounts will also vary by insurance carrier. In the embodiments herein, systems and methods for these varying surcharge amounts among underwriters to be advantageously averaged out or factored into a particular underwriter's risk score are disclosed.

In an embodiment, an average (mean) or median of risk scores can be calculated to generate a composite risk score or a modified composite risk score (e.g., wherein the high value and low value risk scores are discarded and the remaining values are averaged determine the composite risk score). Moreover, the risk scores determined by each insurer can be correlated with the composite risk score to determine, for example, whether the risk scores are above or below a norm for the particular medical condition.

In an embodiment, the composite risk score associated with a particular medical condition can be can be correlated with risk scores from one or more underwriters to route medical records in an automated insurance underwriting process. For example, a medical condition insurability risk evaluation can be used to automatically route medical records associated with a particular individual to an underwriter that evaluates the particular medical condition at or below the composite risk score, rather than to a low-scoring underwriter offering high premiums or declining coverage. In another example, composite risk scores associated with a particular medical condition can be used to generate a selected pool of underwritten insurance policies.

In accordance with the embodiments herein, a medical condition insurability risk evaluation is based on a process for generating a medical report with data from an individual's medical records. In such a process, relevant data from medical record files is first extracted and then normalized based on standardized codes (e.g., ICD-10-CM disease and ICD-10-PCS procedure codes) or synthetic codes based on multiple variables (e.g., combinations of medical conditions, pain scales or measurements). The generated medical report then may be formatted for input to an automated insurance underwriting process supporting life, health, disability and other insurance coverage.

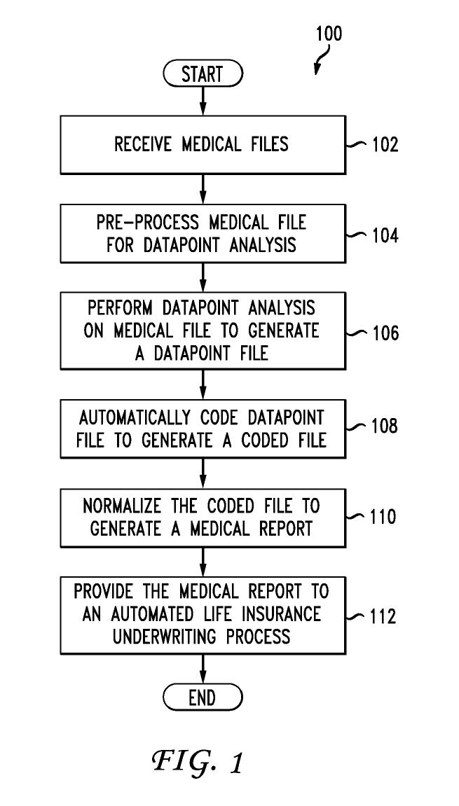

FIG. 1 is a flowchart of a process for generating a medical record in accordance with an embodiment. Process 100 presents methods employed for medical record processing. One skilled in the art will note that while the methods presented herein are exemplary, the following should not be considered as limiting as far as the particular techniques of medical record processing that may be employed. For example, one exemplary but not limiting medical record processing approach is the approach described in U.S. patent application Ser. No. 13/474,222, entitled “Medical Record Processing”, which is incorporated herein by reference.

In process 100, data point analysis is performed on a medical file to generate a data-point file, the data-point file is automatically coded to generate a coded file and the coded file is normalized to generate a medical report. For example, a medical file is received at a workflow manager at 102. At 104, the medical file is pre-processed for data-point analysis. Pre-processing may include removing non-relevant information from the medical file, such as regulatory or personal information. At 106, data point analysis is performed on the medical file to generate a data-point file. In one embodiment, data point analysis may be performed based on a predefined data point specification. For example, the data point specification may be based on one or more coding standards such as CPT, MeSH, MIB, ICD-10, ICD-10-PCS or ICD-10-CM. Performing data point analysis also may include identifying probable errors in the medical file (e.g., clearly erroneous notations of diagnoses or prescribed medications), and correcting such erroneous data.

The data-point file is automatically coded to generate a coded file at 108. For example, the data-point file may comprise a plurality of data-points and automatically coding the data-point file (e.g., via a coding engine) may comprise assigning one or more CPT, MeSH, MIB, ICD-10, ICD-10-PCS or ICD-10-CM codes or, alternatively, synthetic codes to the data-points. At 110, the coded file is normalized to generate a medical report. In one embodiment, the automatic coding at 108 may be based at least in part on feedback from one or more prior normalizations.

At 112, the medical report is received by an automated insurance underwriting process, such as via a secure client upload (e.g., either via a network or a direct connection). In one embodiment, a correlation may be determined between the coded file and mortality or life expectancy data, and the correlation may be provided to the automated insurance underwriting process (e.g., along with the medical report). For example, a life expectancy prediction may be determined based on the correlation. In one embodiment, mortality data may be expressed as one or more mortality risk (MR) values that may be automatically provided in association with the medical report.

In another embodiment, a correlation may be determined between the coded file and reported individual or group symptoms or medical test results, e.g., to determine a medical condition associated with the coded file. Thus, in the context of a coded file correlation, a medical condition can include a medical condition diagnosis, individual or group symptoms or medical test results. The correlation may be provided to the automated insurance underwriting process.

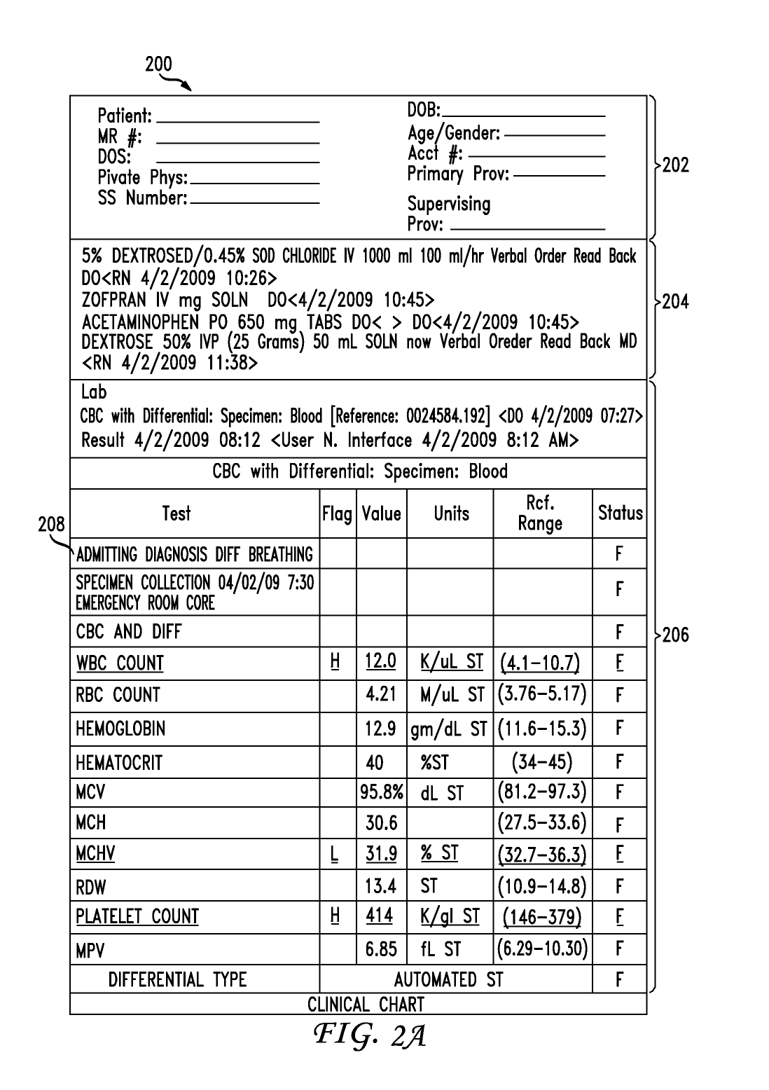

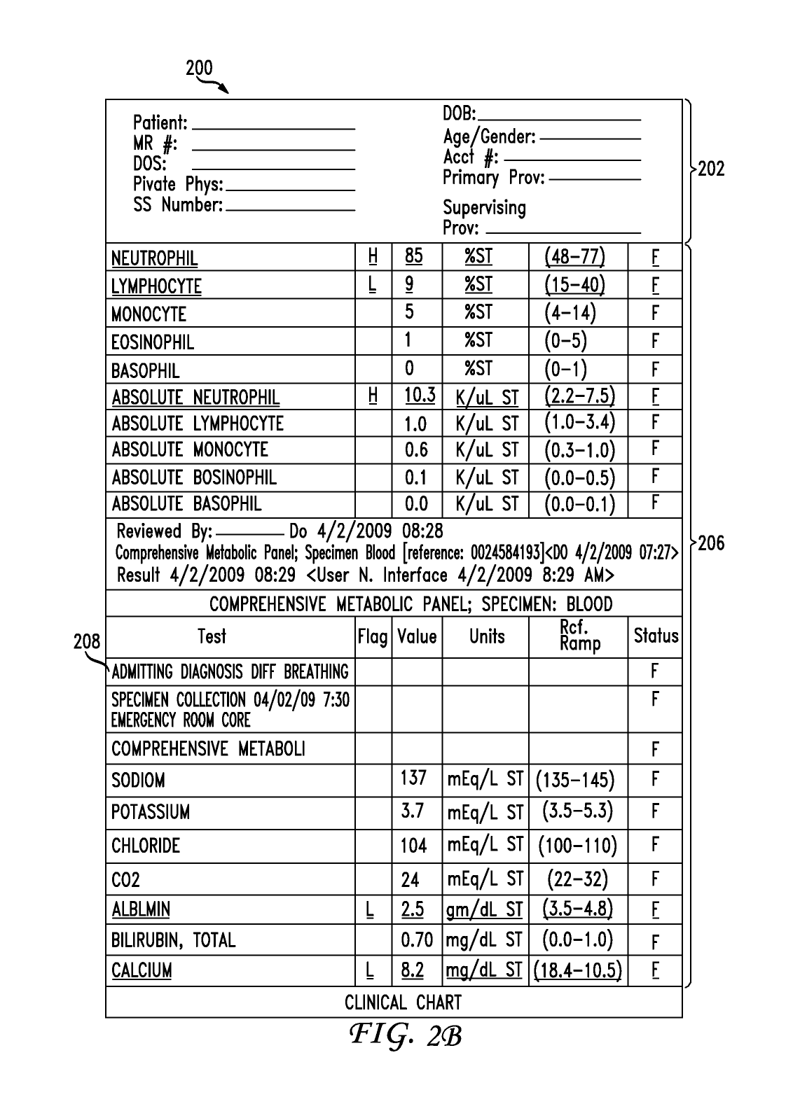

FIGS. 2A and 2B illustrate pages of a medical file in accordance with an embodiment. For example, medical file 200 may contain patient information 202, including address and billing information for an individual. Medical file 200 may also contain data associated with doctor visits including, treatments and prescribed medications 204, test results 206, diagnoses 208, and other data. Medical file 200 also may contain additional information, such as regulatory, administrative or general medical data.

A workflow manager (e.g., a pre-processing unit) may coordinate steps for processing a medical file 200 to generate a medical report. For example, a workflow manager may coordinate the pre-processing of a medical file 200 by providing medical file 200 (e.g., a medical file stored in a database) to a pre-processing function. A pre-processing function may include ordering (e.g., organizing and/or classifying), typing and/or sorting medical file 200 for subsequent processing steps. For example, ordering, typing or sorting operations for a medical file may include converting data (e.g., from machine-readable to human-readable formats, or vice versa), matching data with a particular individual or a plurality of individuals, and extracting data (e.g., regulatory or boilerplate sections) that is not relevant to subsequent processing.

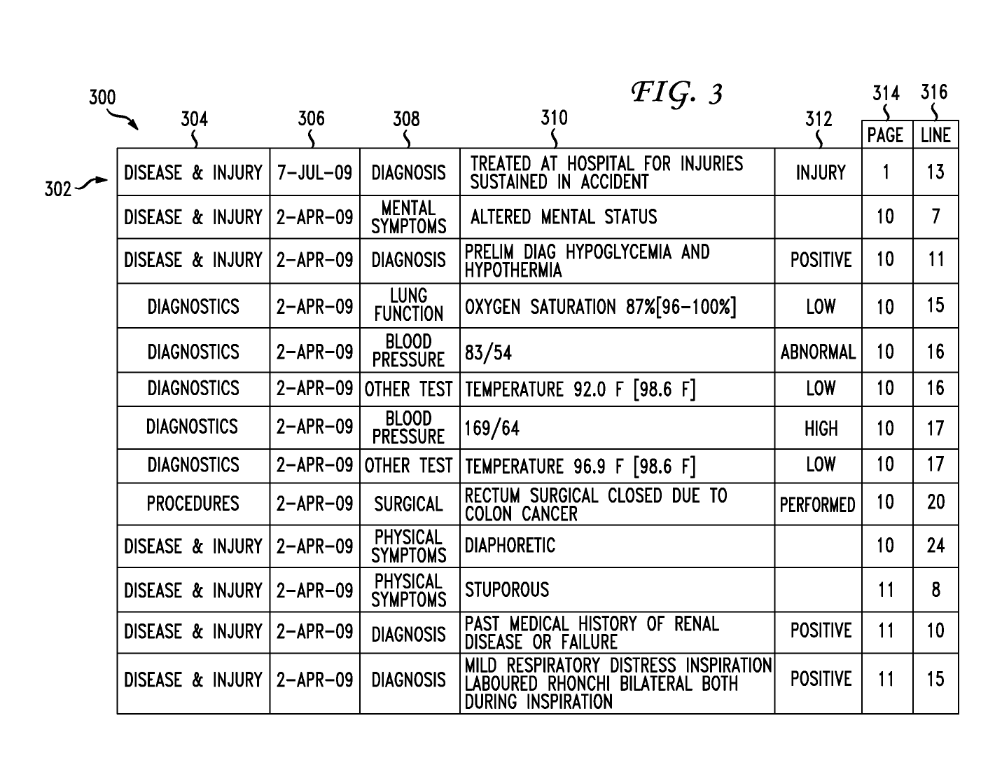

The pre-processed file may be provided to an analysis function for data-point analysis. An analysis function may include data-point analysis operations for analyzing medical file 200 based on one or more data-points to generate a data-point file. A data-point is an extraction of particular data from a medical record in accordance with a specification. The format for data-points may be controlled for consistency, readability and relevancy to medical importance. As shown in FIG. 3, data-point file 300 may be formatted to include one or more data points 302 containing columns for data point descriptions 304, dates-of-entry 306, subject matter 308 (e.g., diagnosis, test, procedure), actions performed/notations 310, assessments 312 and page 314 and line 316 numbers corresponding to the pages/lines containing the data point information in the original medical file 200.

If the data point file is determined to comply with QA standards, the data point file may be provided for coding according to one or more medical record coding standards.

A coding engine may be configured to automatically code a data point file (e.g., based on one or more medical record coding standards, such as CPT, MeSH, MIB, ICD-10, ICD-10-PCS, ICD-10-CM, etc., or synthetic codes) to generate a coded file. For example, a coding engine may be configured analyze a data-point file to identify particular data points, such as data points that are undefined (e.g., data points that do not include a coded entry for a medical condition or diagnosis). A coding engine then may employ search algorithms to determine codes for the particular data points, e.g., to determine a preliminary classification (i.e., a probability ranking) of codes for particular data points based on data analysis (e.g., diagnosis correlation) criteria. For example, a preliminary classification of a particular data point of a data-point file may include rankings of codes that are probable matches for a given diagnosis, wherein the highest ranked code may indicate the best probable match for the given diagnosis. The best probable match then may be included as a final classification for the diagnosis in a coded file.

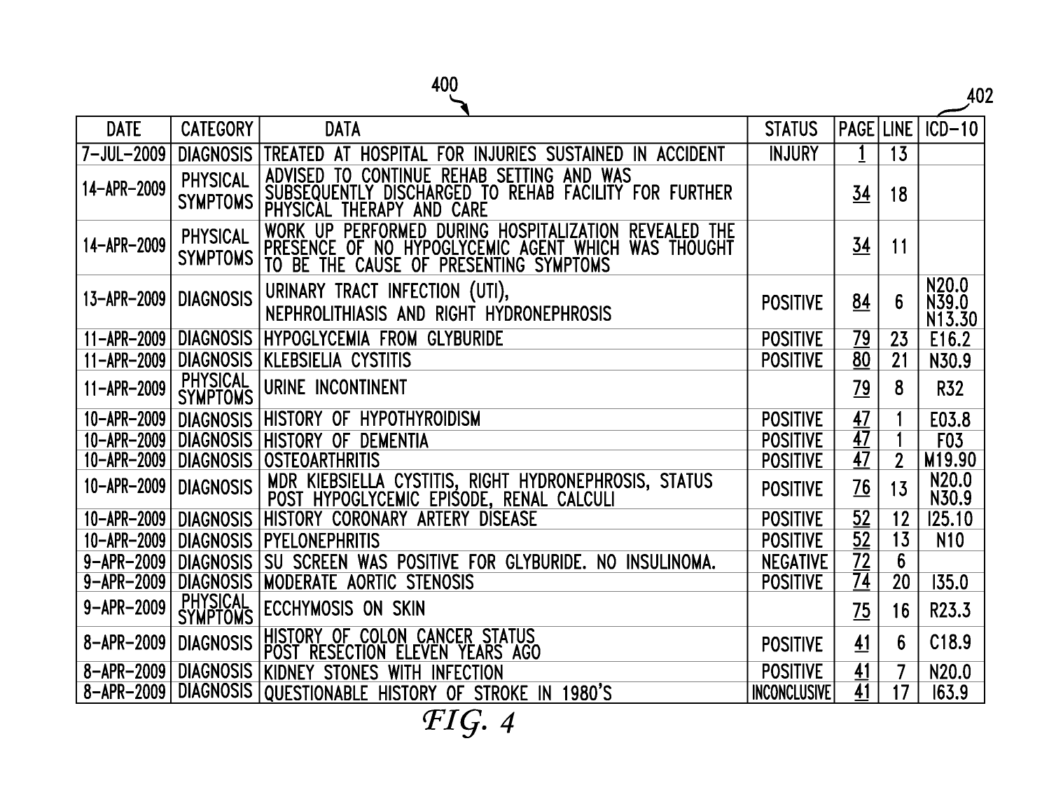

FIG. 4 illustrates a coded file wherein the data-points are coded according to one or more medical record coding standards in accordance with an embodiment. For example, coded file 400 may include a column 402 wherein one or more standard medical codes (such as CPT, MeSH, MIB, ICD-10, ICD-10-PCS or ICD-10-CM codes) or synthetic codes are assigned to the data-points. Further, standard industry codes may be translated into proprietary codes (such as Medical Information Bureau (MIB) Codes) for automated processing. For example, standard codes may be mapped to proprietary codes by accessing an MIB database of shared disease codes reported by the insurance industry.

When a coded file is generated, a normalization function may be employed on the coded file to generate a medical report. In one embodiment, a coded file is formatted to a standard code of disease classification, e.g., ICD-10-CM, for an automated insurance underwriting process. For example, the final normalization may be to a symbolic code that represents the disease, such as the ICD-10-CM classification (Z88.0) for an allergy to penicillin. Alternatively, a coded file can be normalized, either automatically, semi-automatically or manually (e.g., by humans), to generate a medical report. The medical report then may be provided to an automated insurance underwriting process (e.g., uploaded to an automated insurance underwriting process via a network or a direct interface connection).

It should be noted that while the one or more steps for processing a medical file are described herein as being distinct processing steps, these divisions are included solely for the purposes of clarity and ease of understanding. Moreover, one skilled in the art will recognize that one or more of the various steps may be consolidated (e.g., into fewer steps) or expanded (e.g., to include one or more additional steps or sub-steps), and that the processing steps presented herein, while exemplary, are not intended to preclude other methods of implementation.

The one or more steps for processing a medical file to generate a medical report also may be used for generating a synthetic or engineered pool of underwritten insurance policies, e.g., to provide for a securitized financial instrument or another financial services device. For example, insurance underwriters may wish to generate a synthetic or engineered pool of underwritten insurance policies to distribute the risk of underwritten insurance policies, such as in cases where clients are deemed to be uninsurable (e.g., for medical risk that typically cannot be underwritten). Once data regarding a plurality of medical reports is accessible to an insurance underwriter, a normative risk element (e.g., a medical condition) associated with data in a plurality of normalized medical reports can be identified. A magnitude of the normative risk element can then be determined for each of a plurality of normalized medical reports.

For example, a plurality of risk performance standards or metrics can be generated that correlate with the magnitude of the normative risk element for each of the plurality of medical reports. The plurality of underwritten insurance policies can then be associated based on the plurality of risk performance standards or metrics, wherein the plurality of underwritten insurance policies comprise a synthetic or engineered pool of underwritten insurance policies.

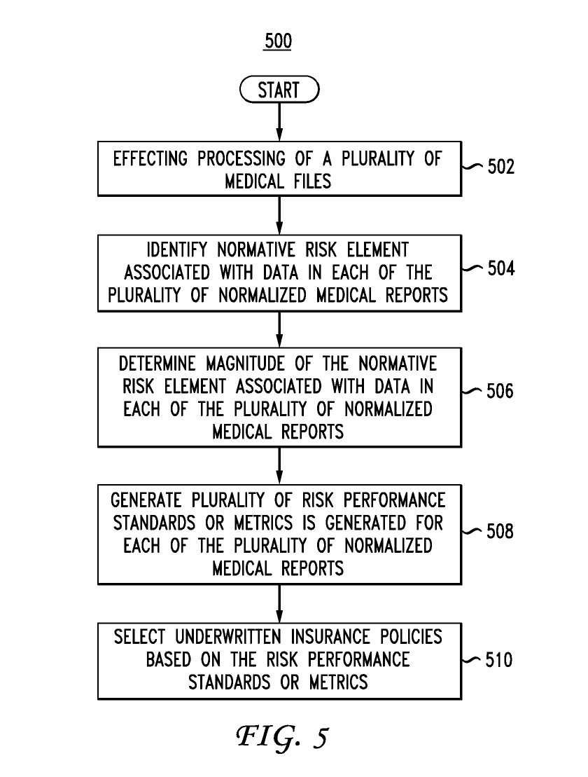

FIG. 5 is a flowchart of a process for generating a selected pool of underwritten insurance policies in accordance with an embodiment. Process 500 presents one embodiment of the methods employed for associating underwritten insurance policies. One skilled in the art will note that while the methods presented herein are exemplary, the following should not be considered as limiting as far as the particular techniques of generating a selected pool of underwritten insurance policies that may be employed. For example, one exemplary but not limiting approach is the approach described in U.S. patent application Ser. No. 13/907,245, entitled “Method for Generating a Selected Pool of Underwritten Insurance Policies”, which is incorporated herein by reference.

At 502, the process 500 includes effecting processing of a plurality of medical files (associated with one or more individuals) in a shared medical data platform to generate a plurality of normalized medical reports. As described above, normalized medical reports include normalized medical data (e.g., normalized XML data), including one or more critical disease elements. In an embodiment, the normalized medical reports may conform to various insurance data standards, such as one or more Association for Cooperative Operations Research and Development insurance data standards (e.g., the Association for Cooperative Operations Research and Development life insurance data standards). In addition, normalized medical reports may be structurally grouped into categories that include general health information, disease type, symptoms of disease, injuries, general diagnostic testing, biochemistry, microbiology and pathology, imaging, endoscopy, medical procedures and surgeries, medications and prescriptions, family history and restrictions.

At 504, a normative risk element associated with data in each of the plurality of normalized medical reports is identified. For example, a normative risk element may be associated with normalized medical data including one or more critical disease elements.

A normative risk element also may be further associated with additional data obtained as a result of an insurance underwriting process. Additional data may include correlations determined between the coded files underlying the normalized medical reports. These correlations may include mortality or life expectancy data provided to an automated insurance underwriting process (e.g., along with the normalized medical reports). For example, a life expectancy prediction may be determined based on one or more correlations. Correlations also may be provided for predicting future disease trends.

A magnitude of the normative risk element associated with data in each of the plurality of normalized medical reports is determined at 606. For example, mortality data (e.g., expressed numerically as one or more mortality risk (MR) values) may be determined in association with each of the normalized medical reports.

At 508, a plurality of risk performance standards or metrics is generated for each of the plurality of normalized medical reports. In an embodiment, the plurality of risk performance standards or metrics include values that correlate with the determined magnitude of the normative risk element for each of the plurality of normalized medical reports. For example, the risk performance standards or metrics may be numeric indicators representative of a magnitude of a particular normative risk. Alternatively, the risk performance standards or metrics may be non-numeric indicators (e.g., coded indicators) that correlate to a magnitude or a potential for a particular normative risk.

At 510, underwritten insurance policies (associated with the plurality of normalized medical reports) are selected based on the risk performance standards or metrics, wherein the underwritten insurance policies comprise a synthetic or engineered pool of underwritten insurance policies. A synthetic or engineered pool may be based on either a correlation or a contrast of risk performance metrics between the underwritten insurance policies. The synthetic or engineered pool may be grouped to balance, compliment or offset certain types of risk. As such, a synthetic or engineered pool may be based on balancing risk factors, as well as on grouping together insurance policies with similar risk attributes. For example, an underwritten insurance policy may be either included or excluded from a synthetic or engineered pool based on a value of a risk performance metric.

An underwriter typically determines insurance premiums according to an internally generated evaluation of insurability risk, e.g., medical condition insurability risk scores (also referred to herein as risk scores) for one or more specific medical conditions. For example, risk scores may be based on a benchmark presumptive standard client. A presumptive standard client may be a benchmark client who can be afforded insurance coverage at 100% of a premium. As such, a risk score may be expressed as a percentage above or below a standard premium (e.g., premium+50%). Alternatively, a risk score may be expressed as a monetary value that is above or below a standard premium (e.g., premium+$2,000). Therefore, based on positive medical history and other factors, a determined risk score may lower a client's premium to a value below the benchmark premium (e.g., less than 100% of the benchmark premium). Conversely, a determined risk score influenced by a client's impairments (e.g., known based on client disclosure or medical records and other records that are processed as described herein) may result in a premium that is greater than the benchmark premium (e.g., a premium that is classified within a rated category).

In an embodiment, a data store may include underwriting criteria for multiple underwriters (e.g., underwriting tables, procedures and manuals), and the stored underwriting criteria may be used to determine risk scores for each medical condition represented in a pool. For example, a data store may comprise multiple table-based risk matrices (e.g., typically 16 or more) maintained by insurers, including decline tables that indicate threshold conditions for which a customer is not insurable at any rate. As such, an underwriter may decline to issue a policy for Alzheimer's disease, add a 200% premium surcharge for a severe condition of Crohn's disease, or add a 150% premium surcharge for well-controlled diabetes based on table-based risk matrices included in the data store.

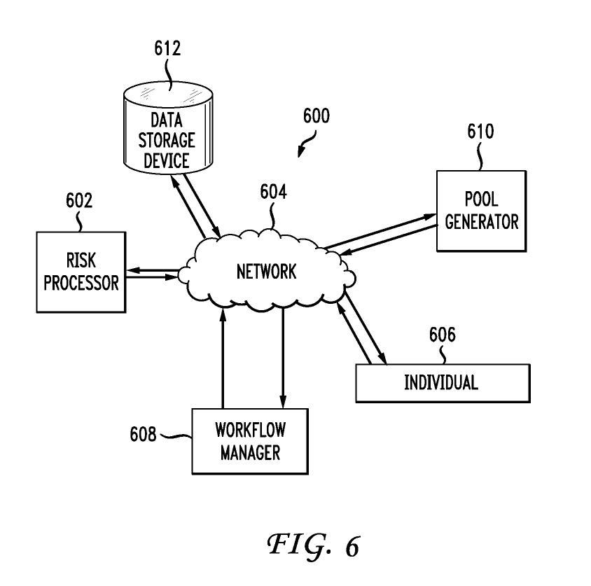

In an embodiment, a novel method for evaluating medical condition insurability risk includes a determination of presumptive and composite insurability risk scores based on underwriting criteria for multiple underwriters. FIG. 6 is a workflow diagram showing an environment that may be used for evaluating medical condition insurability risk in accordance with an embodiment. In environment 600, risk processor 602 is configured to receive a digital communication associated with an individual including an indication of a medical condition. For example, risk processor 602 may receive the digital communication via network 604 from an individual 606 directly, from a workflow manager 608 for processing medical files, or from an insurance pool generator 610 for generating pools of underwritten insurance policies. As such, individual 606 may disclose a particular medical condition or symptoms in response to a web-based medical condition questionnaire, e.g., by entering a response via a user interface. Workflow manager 608 may indicate a medical condition to include an insurability risk evaluation with a medical report, e.g., as an input to an automated insurance underwriting process, while insurance pool generator 610 may indicate a medical condition to integrate a consideration of insurability risk into a process for generating pools of underwritten insurance policies.

Based on the indication of the medical condition and the nature of the digital communication, risk processor 602 is configured to generate a presumptive medical condition risk score, a composite medical condition risk score or both. For example, if the digital communication is received as part of a no-charge insurance underwriting service, e.g., a publicly accessible web-based service, risk processor 602 may generate a presumptive medical condition risk score based on the indicated medical condition and presumptive medical condition risk criteria, such as insurance underwriter-provided risk tables. Alternatively, if the digital communication is received as part of a fee-based insurance underwriting service, risk processor 602 may be configured to retrieve one or more medical records associated with individual 606 via a data store such as data storage device 612, and generate a composite medical condition risk score based on the one or more medical records. For example, the one or more medical records associated with the individual may include a medical report generated by a process such as described above.

Moreover, risk processor 602 may be configured to generate a presumptive medical condition risk score and a composite medical condition risk score as part of a two-part process in which the presumptive medical condition risk score is generated in response to a selection at an interface of a no-charge insurability risk evaluation, and the composite medical condition risk score is generated in response to a selection of a fee-based insurability risk evaluation. As such, risk processor 602 may be further configured to provide a correlation of the presumptive medical condition risk score and the composite medical condition risk score. For example, the correlation may be provided to workflow manager 608 for directing a medical report to a particular insurance underwriter (e.g., to provide preferred insurance rates) or to insurance pool generator 610 for generating pools of underwritten insurance policies based on the correlation.

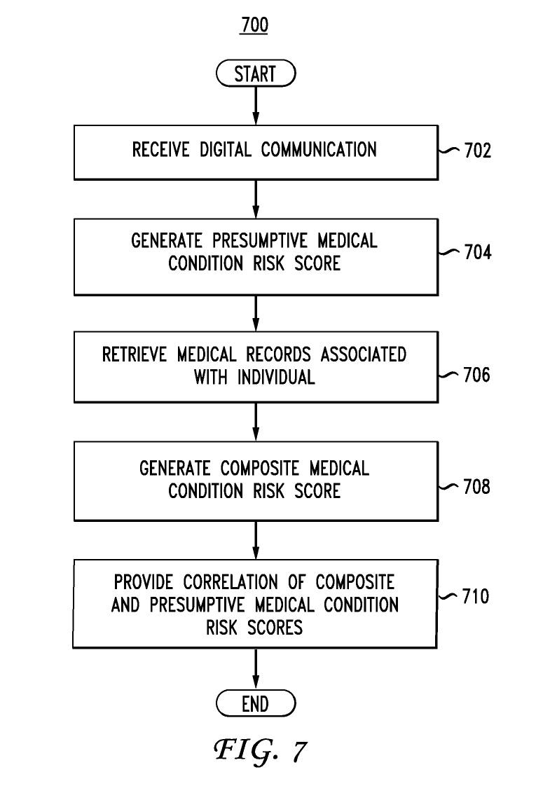

FIG. 7 is a flowchart of a process for evaluating medical condition insurability risk in accordance with an embodiment. Process 700 presents a method that may be based on a method of processing medical files for an automated insurance underwriting process, or a method of generating a selected pool of underwritten insurance policies as described above. For example, underwritten insurance policies may be associated and offered for reinsurance or securitization purposes based on a correlation between a presumptive and composite risk score associated with a particular medical condition.

At 702, a digital communication is received from an individual including an indication of a medical condition. An individual may indicate a medical condition by either disclosing a particular medical condition or by disclosing symptoms that can be interpreted as being indicative of a particular medical condition. For example, the individual may disclose a particular medical condition or symptoms in response to a medical condition questionnaire, e.g., by entering a response via a web-based interface.

At 704, a presumptive medical condition risk score is generated based on the indication of the medical condition and presumptive medical condition risk criteria. The presumptive medical condition risk criteria may include insurability criteria provided by an insurance underwriter and a determined benchmark premium. In an embodiment, the presumptive medical condition risk score may be generated as part of a no-charge insurance underwriting service such as a web-based service accessible to individuals. For example, in a no-charge insurance underwriting service an individual may answer one or more medical information questions based on their knowledge of their own health. A record may be setup based on the medical information answers provided, and a preliminary non-validated score may be generated. To validate the score, the individual may authorize a release of their medical records, e.g., via an attending physician statement (APS).

At 706, one or more medical records associated with the individual are retrieved via data storage device 612, e.g., as a result of receiving a selection for a fee-based insurance underwriting service. For example, an individual may be charged a fee to validate medical information that may affect a risk score. The individual may also be charged a fee to cover costs of obtaining medical records, including pharmacy records or other records. For example, the one or more medical records may comprise normalized medical reports that include normalized medical data, the normalized medical data including one or more critical disease elements. The normalized medical reports may conform to one or more Association for Cooperative Operations Research and Development insurance data standards. One or more other records associated with the individual may be retrieved via the digital storage medium, and the composite medical condition risk score may be generated based on the one or more other records. For example, the one or more other records associated with the individual may include one of a driving history record or a pharmacy history record.

At 708, a composite medical condition risk score is generated based on the one or more medical records associated with the individual. The composite medical condition risk score may be generated based on one of an average, median or modified average of medical condition risk scores associated with multiple insurance underwriters. For example, each medical condition risk score may be based on stored insurability criteria provided by an insurance underwriter. In an embodiment, the composite medical condition risk score may be generated as part of the fee-based insurance underwriting service discussed above.

At 710, a correlation of the presumptive medical condition risk score and the composite medical condition risk score is provided. In an embodiment, the correlation may allow for bulk placement of individuals seeking primary insurance or reinsurance with particular insurance carriers, e.g., insurance carriers who underwrite a specific level of risk or particular medical conditions. For example, some insurance carriers may underwrite an individual diagnosed with HIV, but not all. However, information obtained from a risk score and components of the risk score as to specific diseases, may be used to route the individual to a particular carrier for coverage, or to pool individuals for reinsurance or to create a financial instrument. As such, the correlation of the presumptive medical condition risk score and the composite medical condition risk score may be provided to one of an insurance underwriter or an insurance underwriting broker, wherein the composite medical condition risk score may cause synthetic or engineered pools to be routed to a particular insurance underwriter based on a stored medical condition risk score to provide for preferred reinsurance rates.

In an embodiment, insurance underwriters or insurance underwriting brokers also may be ranked (e.g., given a comparative stack ranking) based on the correlation of the presumptive medical condition risk score and the composite medical condition risk score, and the ranking may be provided to the individual. For example, the ranking may be a general overall ranking or a ranking based on one or more medical conditions associated with the individual.

Therefore, an average (mean) or median of risk scores can be calculated to generate a composite risk score or a modified composite risk score (e.g., wherein the high value and low value risk scores are discarded and the remaining values are averaged determine the composite risk score). Moreover, the risk scores determined by each insurer can be correlated with a composite risk score, e.g., to determine whether the risk scores are above or below a norm for the particular medical condition. As such, the composite risk score for a particular medical condition can be correlated with risk scores from one or more underwriters to route medical records in an automated insurance underwriting process, or to generate a selected pool of underwritten insurance policies.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIGS. 1, 5 and 7. Certain steps of the methods described herein, including one or more of the steps of FIGS. 1, 5 and 7, may be performed by a server or by another processor in a network-based cloud-computing system. Certain steps of the methods described herein, including one or more of the steps of FIGS. 1, 5 and 7, may be performed by a client computer in a network-based cloud computing system. The steps of the methods described herein, including one or more of the steps of FIGS. 1, 5 and 7, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 1, 5 and 7, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

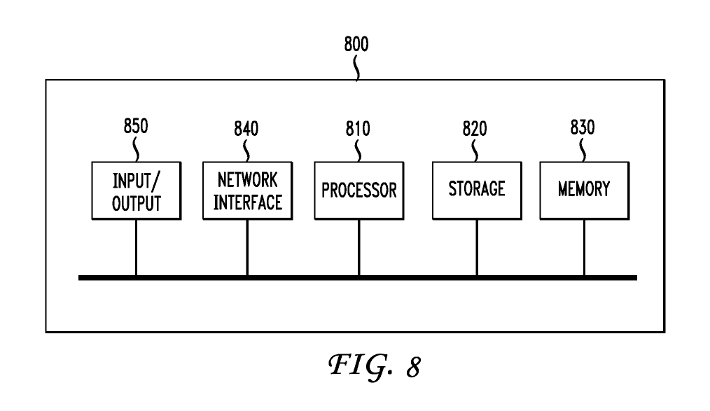

A high-level block diagram of an exemplary computer that may be used to implement systems, apparatus and methods described herein is illustrated in FIG. 8. Computer 800 comprises a processor 810 operatively coupled to a data storage device 820 and a memory 830. Processor 810 controls the overall operation of computer 800 by executing computer program instructions that define such operations. The computer program instructions may be stored in data storage device 820, or other computer readable medium, and loaded into memory 830 when execution of the computer program instructions is desired. Thus, the method steps of FIGS. 1, 5 and 7 can be defined by the computer program instructions stored in memory 830 and/or data storage device 820 and controlled by processor 810 executing the computer program instructions. For example, the computer program instructions can be implemented as computer executable code programmed by one skilled in the art to perform an algorithm defined by the method steps of FIGS. 1, 5 and 7. Accordingly, by executing the computer program instructions, the processor 810 executes an algorithm defined by the method steps of FIGS. 1, 5 and 7. Computer 800 also includes one or more network interfaces 840 for communicating with other devices via a network. Computer 800 also includes one or more input/output devices 850 that enable user interaction with computer 800 (e.g., display, keyboard, mouse, speakers, buttons, etc.).

Processor 810 may include both general and special purpose microprocessors, and may be the sole processor or one of multiple processors of computer 800. Processor 810 may comprise one or more central processing units (CPUs), for example. Processor 810, data storage device 820, and/or memory 830 may include, be supplemented by, or incorporated in, one or more application-specific integrated circuits (ASICs) and/or one or more field programmable gate arrays (FPGAs).

Data storage device 820 and memory 830 each comprise a tangible non-transitory computer readable storage medium. Data storage device 820, and memory 830, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 850 may include peripherals, such as a printer, scanner, display screen, etc. For example, input/output devices 850 may include a display device such as a cathode ray tube (CRT), plasma or liquid crystal display (LCD) monitor for displaying information to the user, a keyboard, and a pointing device such as a mouse or a trackball by which the user can provide input to computer 800.

Any or all of the systems and apparatus discussed herein, including a workflow manager, coding engine and risk processor may be implemented using a computer such as computer 800.

One skilled in the art will recognize that an implementation of an actual computer or computer system may have other structures and may contain other components as well, and that FIG. 8 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

We claim:

1. A method for evaluating medical condition insurability risk, the method comprising:
receiving a digital communication including an indication of a medical condition associated with an individual;
generating a presumptive medical condition risk score for the individual based on the indication of the medical condition and presumptive medical condition risk criteria;
retrieving one or more medical records associated with the individual via a data storage device;
generating a composite medical condition risk score for the individual based on the one or more medical records; and
determining a correlation between the presumptive medical condition risk score and the composite medical condition risk score.

2. The method of claim 1, wherein the correlation between the presumptive medical condition risk score and the composite medical condition risk score is provided to one of an insurance underwriter or an insurance underwriting broker.

3. The method of claim 1, further comprising:
retrieving one or more other records associated with the individual; and
generating the composite medical condition risk score based on the one or more other records.

4. The method of claim 3, wherein the one or more other records associated with the individual include one of a driving history record or a pharmacy history record.

5. The method of claim 1, further comprising generating the composite medical condition risk score based on one of an average, median or modified average of stored medical condition risk scores associated with insurance underwriters.

6. The method of claim 5, wherein each stored medical condition risk score is based on insurability criteria provided by an insurance underwriter.

7. The method of claim 5, further comprising routing the correlation of the presumptive medical condition risk score and the composite medical condition risk score to a particular insurance underwriter to provide for preferred reinsurance rates based on a stored medical condition risk score.

8. The method of claim 1, wherein the presumptive medical condition risk score is generated as part of a no-charge insurance underwriting service.

9. The method of claim 1, wherein the composite medical condition risk score is generated as part of a fee-based insurance underwriting service.

10. The method of claim 1, wherein the one or more medical records comprise normalized medical reports that include normalized medical data, the normalized medical data including one or more critical disease elements.

11. The method of claim 10, wherein the normalized medical reports conform to one or more Association for Cooperative Operations Research and Development insurance data standards.

12. The method of claim 1, wherein the indication of the medical condition is based on a response to a medical condition questionnaire.

13. The method of claim 1, further comprising:
ranking insurance underwriters or insurance underwriting brokers based on the correlation of the presumptive medical condition risk score and the composite medical condition risk score; and
providing the ranking to the individual.

14. The method of claim 13, wherein the ranking is based on the medical condition associated with the individual.

15. An apparatus for evaluating medical condition insurability risk, the apparatus comprising:
a data storage device storing computer program instructions; and
a processor communicatively coupled to the data storage device, the processor configured to execute the computer program instructions, which, when executed on the processor, cause the processor to perform operations comprising:
receiving a digital communication including an indication of a medical condition associated with an individual;
generating a presumptive medical condition risk score for the individual based on the indication of the medical condition and presumptive medical condition risk criteria;
retrieving one or more medical records associated with the individual via a data storage device;
generating a composite medical condition risk score for the individual based on the one or more medical records; and
determining a correlation between the presumptive medical condition risk score and the composite medical condition risk score.

16. The apparatus of claim 15, wherein the correlation between the presumptive medical condition risk score and the composite medical condition risk score is provided to one of an insurance underwriter or an insurance underwriting broker.

17. The apparatus of claim 15, the operations further comprising:
retrieving one or more other records associated with the individual; and
generating the composite medical condition risk score based on the one or more other records.

18. The apparatus of claim 17, wherein the one or more other records associated with the individual include one of a driving history record or a pharmacy history record.

19. The apparatus of claim 17, the operations further comprising generating the composite medical condition risk score based on one of an average, median or modified average of stored medical condition risk scores associated with insurance underwriters.

20. The apparatus of claim 19, wherein each stored medical condition risk score is based on insurability criteria provided by an insurance underwriter.

21. The apparatus of claim 19, the operations further comprising routing the correlation of the presumptive medical condition risk score and the composite medical condition risk score to a particular insurance underwriter to provide for preferred reinsurance rates based on a stored medical condition risk score.

22. The apparatus of claim 15, wherein the presumptive medical condition risk score is generated as part of a no-charge insurance underwriting service.

23. The apparatus of claim 15, wherein the composite medical condition risk score is generated as part of a fee-based insurance underwriting service.

24. The apparatus of claim 15, wherein the one or more medical records comprise normalized medical reports that include normalized medical data, the normalized medical data including one or more critical disease elements.

25. The apparatus of claim 24, wherein the normalized medical reports conform to one or more Association for Cooperative Operations Research and Development insurance data standards.

26. The apparatus of claim 15, wherein the indication of the medical condition is based on a response to a medical condition questionnaire.

27. The apparatus of claim 15, the operations further comprising:
ranking insurance underwriters or insurance underwriting brokers based on the correlation of the presumptive medical condition risk score and the composite medical condition risk score; and
providing the ranking to the individual.

28. The apparatus of claim 27, wherein the ranking is based on the medical condition associated with the individual.

29. A computer readable medium storing computer program instructions for evaluating medical condition insurability risk, which, when executed on a processor, cause the processor to perform operations comprising:
receiving a digital communication including an indication of a medical condition associated with an individual;
generating a presumptive medical condition risk score for the individual based on the indication of the medical condition and presumptive medical condition risk criteria;
retrieving one or more medical records associated with the individual via a data storage device;
generating a composite medical condition risk score for the individual based on the one or more medical records; and
determining a correlation between the presumptive medical condition risk score and the composite medical condition risk score.

30. The computer readable medium of claim 29, wherein the correlation between the presumptive medical condition risk score and the composite medical condition risk score is provided to one of an insurance underwriter or an insurance underwriting broker.

31. The computer readable medium of claim 29, the operations further comprising:
retrieving one or more other records associated with the individual; and
generating the composite medical condition risk score based on the one or more other records.

32. The computer readable medium of claim 31, wherein the one or more other records associated with the individual include one of a driving history record or a pharmacy history record.

33. The computer readable medium of claim 29, the operations further comprising generating the composite medical condition risk score based on one of an average, median or modified average of stored medical condition risk scores associated with insurance underwriters.

34. The computer readable medium of claim 33, wherein each stored medical condition risk score is based on insurability criteria provided by an insurance underwriter.

35. The computer readable medium of claim 33, the operations further comprising routing the correlation of the presumptive medical condition risk score and the composite medical condition risk score to a particular insurance underwriter to provide for preferred reinsurance rates based on a stored medical condition risk score.

36. The computer readable medium of claim 29, wherein the presumptive medical condition risk score is generated as part of a no-charge insurance underwriting service.

37. The computer readable medium of claim 29, wherein the composite medical condition risk score is generated as part of a fee-based insurance underwriting service.

38. The computer readable medium of claim 29, wherein the one or more medical records comprise normalized medical reports that include normalized medical data, the normalized medical data including one or more critical disease elements.

39. The computer readable medium of claim 38, wherein the normalized medical reports conform to one or more Association for Cooperative Operations Research and Development insurance data standards.

40. The computer readable medium of claim 29, the operations further comprising:
ranking insurance underwriters or insurance underwriting brokers based on the correlation of the presumptive medical condition risk score and the composite medical condition risk score; and
providing the ranking to the individual.

41. The computer readable medium of claim 40, wherein the ranking is based on the medical condition associated with the individual.
